(19) United States
(12) Patent Application Publication
(10) Pub. No.: US 2016/0165191 A1
(43) Pub. Date: Jun. 9, 2016

(54) TIME-OF-APPROACH RULE

(71) Applicant: AVIGILON FORTRESS CORPORATION, Vancouver (CA)

(72) Inventors: Zeeshan Rasheed, Herndon, VA (US); Weihong Yin, Great Falls, VA (US); Zhong Zhang, Great Falls, VA (US); Kyle Glowacki, Reston, VA (US); Allison Beach, Leesburg, VA (US)

(21) Appl. No.: 14/959,571

(22) Filed: Dec. 4, 2015

Related U.S. Application Data
(60) Provisional application No. 62/088,394, filed on Dec. 5, 2014.
(60) Provisional application No. 62/088,446, filed on Dec. 5, 2014.

(51) Int. Cl. H04N 7/18; G08B 13/196; G06T 7/20

(52) U.S. Cl. CPC H04N 7/185; G06T 7/20; G08B 13/19697

(57) ABSTRACT

A method for predicting when an object will arrive at a boundary includes receiving visual media captured by a camera. An object in the visual media is identified. One or more parameters related to the object are detected based on analysis of the visual media. It is predicted when the object will arrive at a boundary using the one or more parameters. An alert is transmitted to a user indicating when the object is predicted to arrive at the boundary.

### CROSS-REFERENCE TO RELATED APPLICATIONS

This application claims priority to U.S. Provisional Patent Application No. 62/088,394, filed on Dec. 5, 2014, and U.S. Provisional Patent Application No. 62/088,446, filed on Dec. 5, 2014. The disclosure of both of these applications is hereby incorporated by reference.

### U.S. GOVERNMENT RIGHTS

This invention was made with government support under Contract No. M67854-12-C-6548 awarded by the Office of Naval Research. The government has certain rights in the invention.

### FIELD OF DISCLOSURE

This disclosure relates generally to the field of automated monitoring of visual surveillance data and, more particularly, to an automated monitoring system for visual surveillance data, including automated threat detection, identification, and response.

### BACKGROUND

Visual surveillance systems are increasingly being used for site security and threat monitoring. In one example, the visual surveillance system may be used to monitor an object travelling toward a military base. A virtual line (e.g., a “tripwire”) may be placed across a path or road at a predetermined distance (e.g., one mile) away from the military base. When the system visually identifies the object (e.g., a vehicle) crossing the virtual line on the way to the military base, the system may generate a notification or alert so that a user may take action, for example, to analyze the object to determine whether it may present a threat.

The notification may inform the user when the object crosses the virtual line; however, the notification does not inform the user when the object is predicted to arrive at the military base. This prediction may vary substantially for different objects. For example, a vehicle travelling at 60 miles per hour will arrive at the military base in a shorter time than a pedestrian travelling at 2 miles per hour. Therefore, it is desirable to provide an improved automated monitoring system for visual video data, including automated threat detection, identification, and response.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for predicting when an object will arrive at a boundary is disclosed. The method includes receiving visual media captured by a camera. An object in the visual media is identified. One or more parameters related to the object are detected based on analysis of the visual media. It is predicted when the object will arrive at a boundary using the one or more parameters. An alert is transmitted to a user indicating when the object is predicted to arrive at the boundary.

A non-transitory computer-readable medium is also disclosed. The medium stores instructions that, when executed by one or more processors of a computer system, cause the computer system to perform operations. The operations include receiving visual media captured by a camera. The operations also include identifying an object in the visual media. The operations also include determining one or more parameters related to the object. The operations also include predicting when the object will arrive at a boundary using the one or more parameters. The operations also include transmitting an alert over a wireless communication channel to a wireless device. The alert causes a second computer system to auto-launch an application on the second computer system when the wireless device is connected to the second computer system, and the alert indicates when the object is predicted to arrive at the boundary.

A system is also disclosed. The system includes a first computer configured to: receive visual media captured by a camera, identify an object in the visual media, determine one or more parameters related to the object, and predict when the object will arrive at a boundary using the one or more parameters. The system also includes a second computer configured to receive an alert from the first computer that is transmitted over a wireless communication channel. The alert indicates when the object is predicted to arrive at the boundary. The second computer is a wireless device. The system also includes a third computer having an application stored thereon. The third computer is offline when the alert is transmitted from the first computer. When the second computer is connected to the third computer, the alert causes the third computer to auto-launch the application.

### BRIEF DESCRIPTION OF THE DRAWINGS

These and/or other aspects and advantages in the embodiments of the disclosure will become apparent and more readily appreciated from the following description of the various embodiments, taken in conjunction with the accompanying drawings of which:

FIG. 1 illustrates a schematic view of an example of a visual surveillance system capturing an object travelling toward a boundary.

FIG. 2 illustrates a flowchart of an example of a method for predicting when an object will arrive at a boundary.

FIG. 3 illustrates a flowchart of an example of another method for predicting when an object will arrive at a boundary.

FIG. 4 illustrates a schematic view of an example of a computing system that may be used for performing one or more of the methods disclosed herein.

It should be noted that some details of the drawings have been simplified and are drawn to facilitate understanding of the present teachings rather than to maintain strict structural accuracy, detail, and scale. The drawings above are not necessarily to scale, with emphasis instead generally being placed upon illustrating the principles in the present disclosure. Further, some features may be exaggerated to show details of particular components. These drawings/figures are intended to be explanatory and not restrictive.

### DETAILED DESCRIPTION

Reference will now be made in detail to the various embodiments in the present disclosure. The embodiments are described below to provide a more complete understanding of the components, processes, and apparatuses disclosed herein. Any examples given are intended to be illustrative, and not restrictive. Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/ B/B/C, A/B/C, etc. In addition, throughout the specification, the meaning of “a,” “an,” and “the” include plural references. The meaning of “in” includes “in” and “on.”

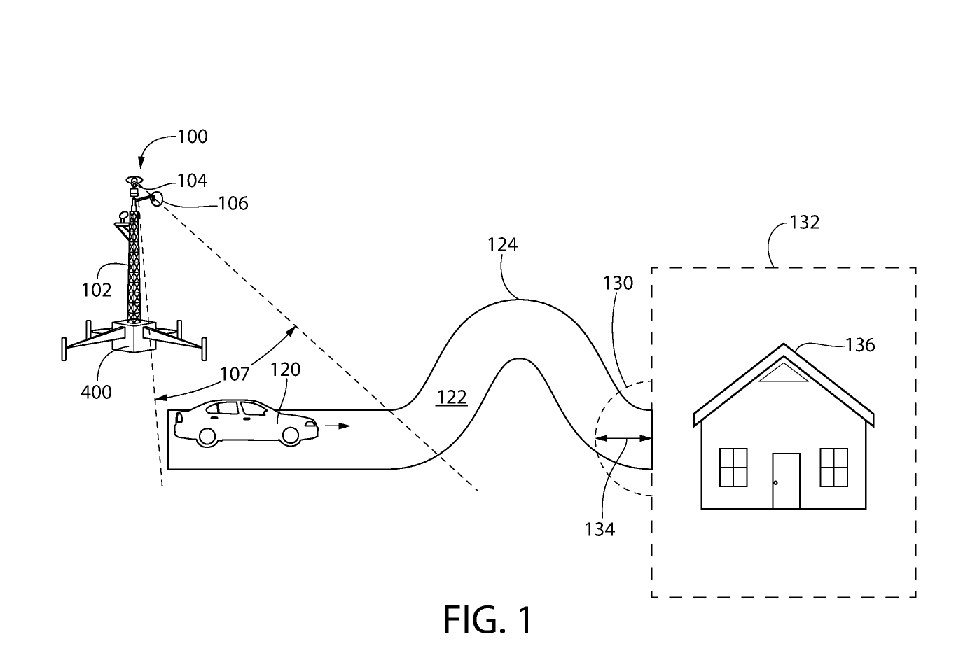

FIG. 1 illustrates a schematic view of a visual surveillance system 100 capturing an object 120 travelling toward a boundary 130. As shown, the object 120 is a vehicle. In other use cases, the object 120 may be one or more people walking, running, riding a bicycle, riding a motorcycle, riding an animal (e.g. a horse), one or more aircrafts (e.g., a plane or helicopter), one or more boats, or the like. The object 120 may be travelling down a predefined path 122 toward the boundary 130. As shown, the path 122 is a road. In other embodiments, the path 122 may be an unpaved trail, a waterway (e.g., a river or canal), or the like.

The boundary 130 may be a virtual trip wire defined in the visual surveillance system 100. The boundary 130 may coincide with an edge of a piece of property 132, or, as shown, the boundary 130 may be spaced away from the piece of property 132 a predetermined distance 134 (e.g., 100 yards). In yet other embodiments, the boundary 130 may not be linked to a piece of property 132. As shown, the boundary 130 may be curved so that it is substantially equidistant from an entrance (e.g., a gate) to the property 132. In other embodiments, the boundary 130 may be substantially linear. For example, the boundary 130 may be the entrance (e.g., the gate) to the property 132. In another example, the boundary 130 may be a street, a river, etc.

In some embodiments, the boundary 130 may not be a single linear segment. For example, the boundary 130 may include a multi-segment tripwire that is made up of more than one linear segment. Furthermore, the boundary 130 may not include a single tripwire; on the contrary, the boundary 130 may include multiple (e.g., parallel) tripwires that may, for example, require the object 120 to cross all of the tripwires in a particular order or within a particular period of time. Additional details about the boundary 130 may be found in U.S. Pat. No. 6,970,083, which is incorporated by reference herein in its entirety.

In at least one embodiment, the user may draw the boundary 130 on a video image, or an image that is a snapshot from a video stream (e.g., such a “snapshot” may be a frame of a video stream or may be separately acquired). This may be done using a “point and click” interface, where a user may select a point on an image using a pointing device, such as a mouse, and then drag the boundary 130 along the image, thus designating the boundary 130. Other components of a boundary rule, such as directionality (e.g., left-to-right, right-to-left, etc.), object type (e.g., human, vehicle, animal, etc.), object speed, etc., may also be selected using a “point-and-click” interface. For example, directionality may be selected as options on a graphical menu selected using, for example, a pointing device, such as a mouse; object type may be selected from a list or pull-down menu using, for example, a pointing device, such as a mouse; and so on.

The property 132 may be or include any area that may be described with geographic coordinates. The property 132 may have an area ranging from one square meter to one square kilometer or more. For example, the property 132 may be or include residential property, commercial property, government property (e.g., a military base), a geographical location (e.g., a turn in a road or a river, a coordinate in the ocean), or the like. The property 132 may have one or more buildings (one is shown: 136) positioned thereon.

The visual surveillance system 100 may be positioned proximate to the boundary 130 and/or proximate to the property 132, as shown in the example of FIG. 1. As shown, the visual surveillance system 100 may be a ground-based operational surveillance system (“G-BOSS”) that includes a tower 102 having imaging devices (e.g., cameras) 104 and/or sensors 106 coupled thereto. The cameras 104 may be video cameras. The sensors 106 may be or include heat-based sensors, sound-based sensors, infrared sensors, or the like. Instead of, or in addition to, the ground-based operational surveillance system, the visual surveillance system 100 may include an aerial surveillance system (e.g., an airplane, a drone, a satellite, etc.) or a maritime surveillance system having one or more imaging devices (e.g., cameras) 104 and/or sensors 106 coupled thereto.

In various embodiments, the visual surveillance system 100 (e.g., the cameras 104) may be equipped with a global positioning system (“GPS”) that provides the geo-location of the visual surveillance system 100 and enables the system to calculate the geo-location of the object 120. The visual surveillance system 100 (e.g., the sensors 106) may also be configured to measure the position, velocity, acceleration, orientation, trajectory, etc. of the object 120. In the embodiment where the visual surveillance system 100 is part of a moving apparatus (e.g., an unmanned aerial vehicle or “UAV”), the visual surveillance system 100 may be equipped with inertial measurement units (“IMUs”) for measuring the position, velocity, acceleration, orientation, trajectory, etc. of the apparatus, which may be used to better determine the position, velocity, acceleration, orientation, trajectory, etc. of the object 120. The camera 104 may capture visual media (e.g., videos or pictures) of any objects 120 travelling toward the boundary 130 and/or the property 132. The camera 104 may have a field of view 107 that that includes the path 122 and/or terrain that is off the path 122 (e.g., in the event that the object 120 is not travelling on the path 122). The object 120 may pass through the field of view 107 of the camera 104, and the object 120 may be captured in the visual media.

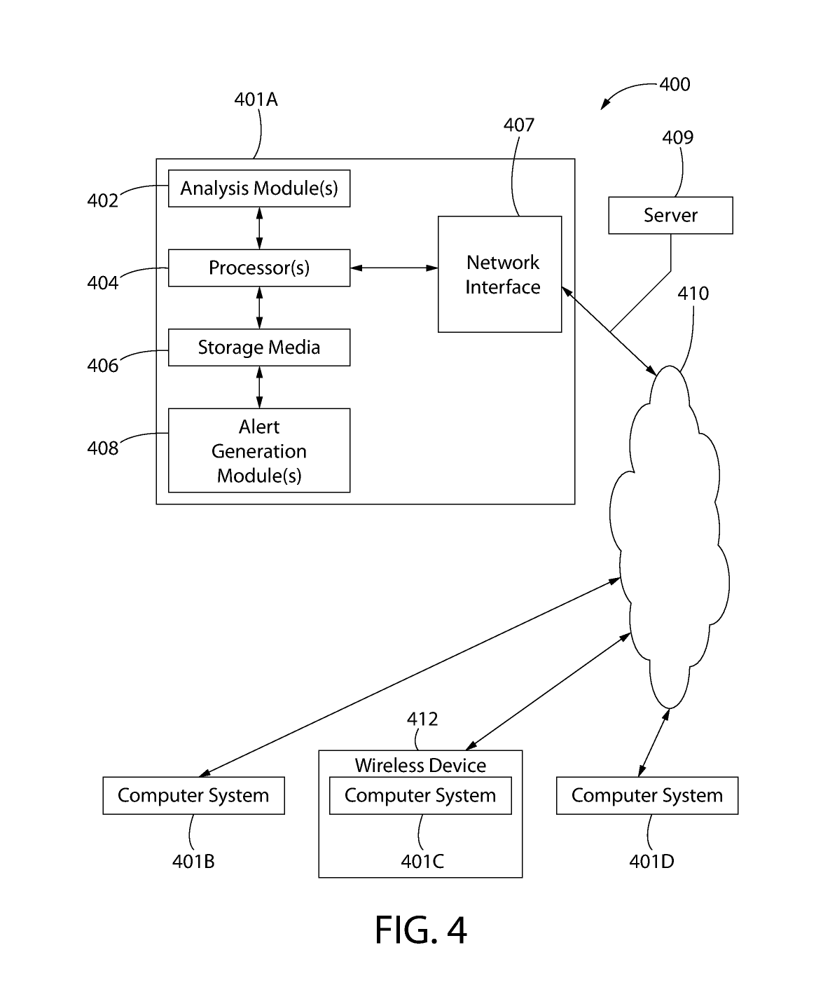

The visual surveillance system 100 may also include a computing system 400 (see FIG. 4) that is configured to receive the visual media from the camera 104 and/or the data from the sensors 106, an optional GPS, and/or an optional IMU. As shown, the computing system 400 may be coupled to or positioned proximate to the tower 102. As used herein, “proximate to” refers to within 10 meters or less. In another embodiment, the computing system 400 may be remote from the tower 102. For example, the tower 102 may be positioned off of the property 132, and the computing system 400 may be positioned on the property 132. The computing system 400 may receive the visual media from the camera 104 and/or the data from the sensors 106 either through a cable or wirelessly.

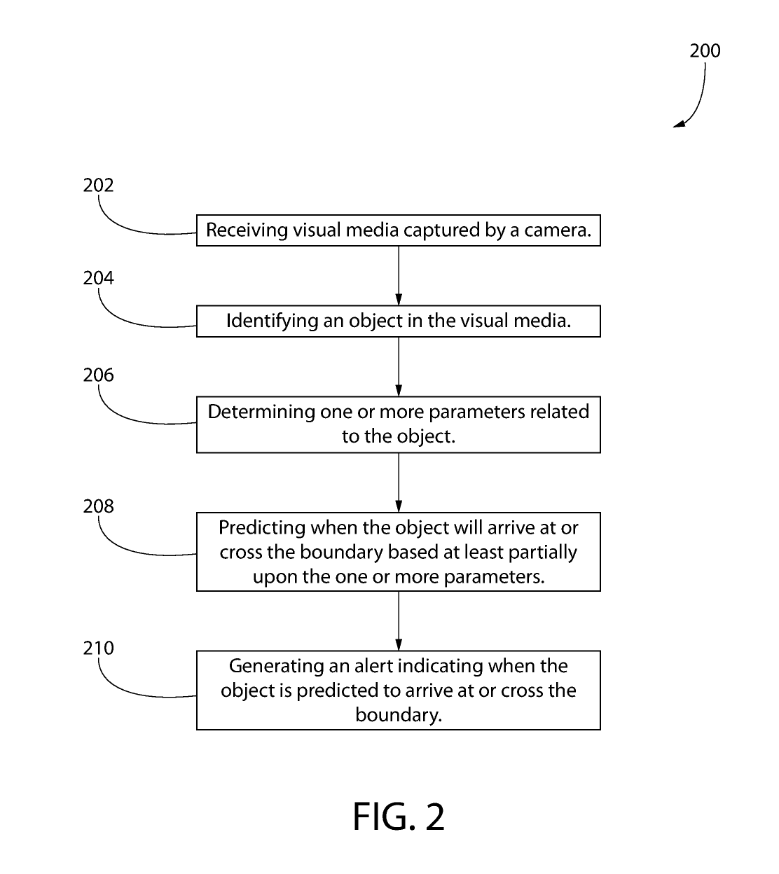

FIG. 2 illustrates a flowchart of a method 200 for predicting when the object 120 will arrive at the boundary 130. The method 200 may begin by receiving visual media (e.g., videos or pictures) captured by the camera 104, as at 202. The visual media may be received by the computing system 400 from the camera 104 substantially in real-time. As used herein, the visual media is received “substantially in real-time” when it is received within 10 seconds or less after being captured by the camera 104. Data may also be received from the sensors 106. The data may include information describing or representing the latitude and/or longitude of the sensor 106 and/or the object 120, the location of the sensor 106, the orientation of the sensor 106 (e.g., roll, pitch, yaw), the distance from the sensor 106 to the object 120, time, IR information on the object 120, and the like. Other information, such as an orientation of the object 120, movement of the object 120, a location of the object 120, a physical size of the object 120, the classification type of the object 120, and the velocity of the object 120, may be derived from the data collected by the sensor 106.

The method 200 may then include detecting and/or identifying the object 120 in the visual media, as at 204. The visual surveillance system 100 may be trained to identify various objects 120 in the visual media. For example, a plurality of sample videos or pictures captured by the camera 104 may be viewed by a user. The user may identify the videos or pictures in which an object is present (yes or positive) and the videos or pictures in which an object is not present (no or negative). In at least one embodiment, in addition to identifying when an object is present, the user may also identify the type of object (e.g., person, vehicle, etc.) and/or the identity of the object. This may be referred to as classification. This information may be used to train the visual surveillance system 100 to identify and classify similar objects (e.g., the object 120 in FIG. 1) in the future.

In at least one embodiment, when the camera 104 captures a video, one or more pictures may be obtained from the video (e.g., by taking screen shots or frames), as it may be easier to identify objects from still pictures. The pictures from the video may be taken with a predetermined time in between (e.g., 1 second). The pictures may then be used to train the visual surveillance system 100, as described above, and once the visual surveillance system 100 is trained, the visual surveillance system 100 may analyze pictures to identify and classify similar objects (e.g., the object 120 in FIG. 1).

The object 120 may also be detected and tracked by motion and change detection sensors. The image or screen shot of a video may be classified into foreground and background regions. Objects of interest may be detected from the foreground regions by temporally connecting all of the corresponding foreground regions. Additional details about identifying the object 120 in the visual media (as at 204) may be found in U.S. Pat. Nos. 6,999,600, 7,391,907, 7,424,175, 7,801,330, 8,150,103, 8,711,217, and 8,948,458, which are incorporated by reference herein in their entirety.

The method 200 may also include determining one or more parameters related to the object 120 from the visual media captured by the camera 104, as at 206. A first parameter may be or include the size and/or type of the object 120. Determining the size of the object 120 may at least partially depend upon first determining the distance between the camera 104 and the object 120, as the object 120 may appear smaller at greater distances. Once the size of the object 120 is determined, this may be used to help classify the type of the object 120 (e.g., person, a vehicle, etc.), as described above. Determining the size of the object 120 may also include determining the height, width, length, weight, or a combination thereof.

A second parameter may be or include the trajectory (i.e., the direction of movement) of the object 120. The trajectory of the object 120 may be in a two-dimensional plane (e.g., horizontal or parallel to the ground) or in three-dimensions. The visual surveillance system 100 may determine the trajectory of the object 120 by analyzing the direction of movement of the object 120 in a video or by comparing the position of the object 120 in two or more pictures taken at different times. A second camera may also be used to capture videos or pictures of the object 120 from a different viewpoint, and this information may be combined with the videos or pictures from the first camera 104 determine the trajectory of the object 120.

A third parameter may be or include the distance between the object 120 and the boundary 130. The distance may be the shortest distance between the object 120 and the boundary 130 (i.e., “as the crow flies”). In another embodiment, the visual surveillance system 100 may first determine whether the object 120 is on the path 122. This may be accomplished by comparing the position of the object 120 to the path 122 at one or more locations along the path 122. In some embodiments, this may also include comparing the trajectory of the object 120 to the trajectory of the path 122 at one or more locations. If the object 120 is on the path 122, the distance may be determined along the path 122 rather than as the crow flies. As shown, the path 122 includes one or more twists or turns 124. As such, the distance along the path 122 is longer than the distance as the crow flies.

A fourth parameter may be or include the speed/velocity of the object 120. Two pictures taken by the camera 104 may be analyzed to determine the velocity. For example, the distance between the position of the object 120 in two different pictures may be 20 feet. It may be known that the time between the pictures is 2 seconds. Thus, the velocity of the object 120 may be determined to be 10 feet/second.

A fifth parameter may be or include the acceleration of the object 120. The visual surveillance system 100 may determine the acceleration of the object 120 by first determining the velocity of the object 120 at two or more times. For example, the velocity of the object 120 may be determined to be 10 feet/second at T₁, and the velocity of the object 120 may be determined to be 20 feet/second at T₂. If T₂−T₁=2 seconds, then the acceleration of the object 120 may be determined to be 5 feet/second².

Other parameters may be or include the color, shape, rigidity, and/or texture of the object 120. Additional details about determining one or more parameters related to the object (as at 206) may be found in U.S. Pat. Nos. 7,391,907, 7,825, 954, 7,868,912, 8,334,906, 8,711,217, 8,823,804, and 9,165,190, which are incorporated by reference herein in their entirety.

The method 200 may also include predicting when the object 120 will arrive at or cross a boundary (e.g., the boundary 130) based at least partially upon the one or more parameters, as at 208. In a first example, the object 120 may be a vehicle on the path 122. The trajectory of the vehicle may be toward the boundary 130 along the path 122. The distance between the vehicle and the boundary 130 along the path 122 may be 1 mile. The velocity of the vehicle may be 30 miles/hour, and the velocity may be constant (i.e., no acceleration). By analyzing one or more of these parameters, the surveillance system may predict that the vehicle will cross the boundary 130 in 2 minutes.

In a second example, the object 120 may be a person that is not on the path 122. The trajectory may be toward the boundary 130 along a straight line (i.e., as the crow flies). The distance between the person and the boundary 130 along the straight line may be 0.5 mile. The velocity of the person may be 2 miles/hour, and the velocity may be constant (i.e., no acceleration). By analyzing one or more of these parameters, the surveillance system may predict that the person will cross the boundary 130 in 15 minutes.

The method 200 may also include generating a notification or alert that informs a user when the object 120 is predicted to arrive at or cross the boundary 130, as at 210. The alert may be in the form of a pop-up box on a display of the visual surveillance system 100 or on a display of a remote device such as a smart phone, a tablet, a laptop, a desktop computer, or the like. In another embodiment, the alert may be in the form of a text message or an email.

The alert may include the predicted amount of time until the object 120 arrives at or crosses the boundary 130 at the time the prediction is made. Thus, in the first example above, the alert may indicate that the vehicle is predicted to cross the boundary 130 in 2 minutes. In the second example above, the alert may indicate that the person is predicted to cross the boundary 130 in 15 minutes.

In another embodiment, the alert may be generated a predetermined amount of time before the object 120 is predicted to cross the boundary 130. The predetermined amount of time may be, for example, 1 minute. Thus, in the first example above, the visual surveillance system 100 may wait 1 minute after the prediction is made and then generate the alert. In the second example above, the visual surveillance system 100 may wait 14 minutes after the prediction is made and then generate the alert.

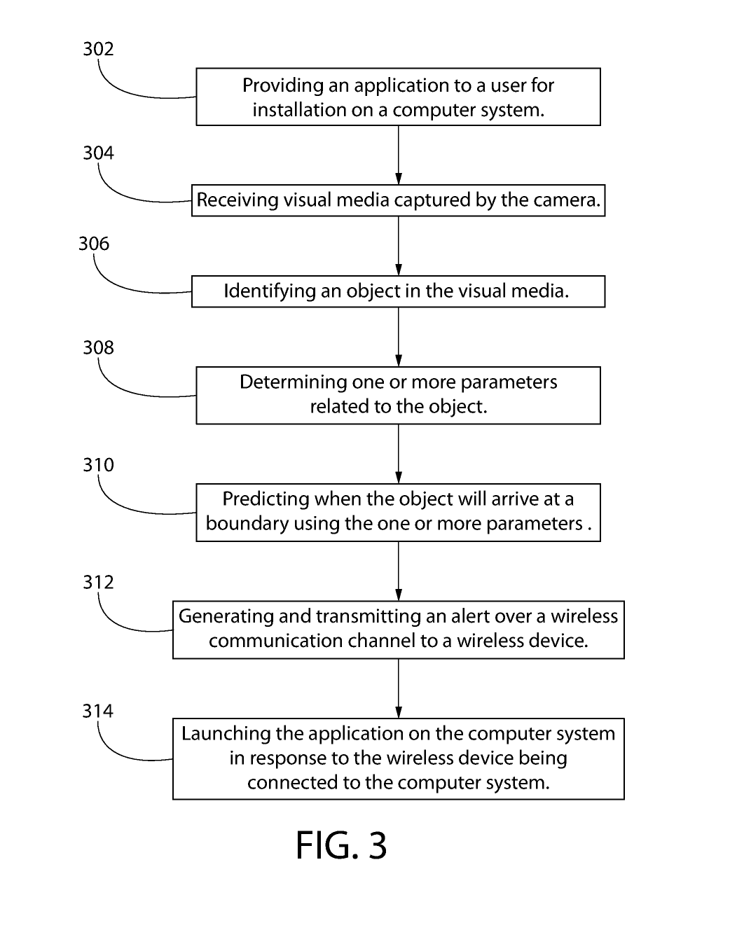

FIG. 3 illustrates a flowchart of an example of another method 300 for predicting when an object 120 will arrive at a boundary 130. The method 300 may include providing an application to a user for installation on a computer system, as at 302. The method 300 may then include receiving visual media (e.g., videos or pictures) captured by the camera 104, as at 304. In at least one embodiment, the visual media may be sent from a data source (e.g., in the visual surveillance system 100) over the Internet and received at a server. The method 300 may then include identifying an object 120 in the visual media, as at 306. The method 300 may then include determining one or more parameters related to the object 120 based on an analysis of the visual media, as at 308. The method 300 may then include predicting when the object 120 will arrive at a boundary 130 using the one or more parameters, as at 310.

In some embodiments, the user's computer system may be offline (e.g., not connected to the Internet) when the object 120 arrives at, or is about to arrive at, the boundary 130. When this occurs, the method 300 may include generating and transmitting an alert over a wireless communication channel to a user's wireless device (e.g., smart phone), as at 312. The alert may display on the wireless device. The alert may include a uniform resource locator (“URL”) that specifies the location of the data source where the visual media is stored (e.g., in the visual surveillance system 100 or the server). The user may then connect the wireless device to the user's computer system, and the alert may cause the computer system to auto-launch (e.g., open) the application, as at 314. When the computer system is connected to the Internet, the user may then click on the URL in the alert to use the application to access more detailed information about the alert (from the data source) such as images and/or videos of the object 120, the parameters of the object 120 (e.g., size, type, trajectory, distance, speed, acceleration, etc.), and the like.

In some embodiments, the methods of the present disclosure may be executed by a computing system. FIG. 4 illustrates an example of such a computing system 400, in accordance with some embodiments. The computing system 400 may include a computer or computer system 401A, which may be an individual computer system 401A or an arrangement of distributed computer systems. The computer system 401A may be part of the visual surveillance system 100, or the computer system 401A may be remote from the visual surveillance system 100. The computer system 401A includes one or more analysis modules 402 that are configured to perform various tasks according to some embodiments, such as one or more methods disclosed herein. For example, the analysis module 402 may be configured to analyze the visual media from the camera 104 and/or the data from the sensors 106 to predict when the object 120 will arrive at the boundary 130. To perform these various tasks, the analysis module 402 executes independently, or in coordination with, one or more processors 404, which is (or are) connected to one or more storage media 406. The processor(s) 404 can include a microprocessor, microcontroller, processor module or subsystem, programmable integrated circuit, programmable gate array, or another control or computing device.

The processor(s) 404 is (or are) also connected to a network interface 407 to allow the computer system 401A to communicate over a data network 410 with one or more additional computer systems and/or computing systems, such as 401B, 401C, and/or 401D (note that computer systems 401B, 401C and/or 401D may or may not share the same architecture as computer system 401A, and may be located in different physical locations, e.g., computer systems 401A and 401B may be located at the site of the tower 102, while in communication with one or more computer systems such as 401C and/or 401D that are located on the property 132). In one embodiment, the computer system 401B may be or include the computer system having the application installed thereon, and the computer system 401C may be part of the wireless device.

The storage media 406 can be implemented as one or more computer-readable or machine-readable storage media. Note that while in some example embodiments of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, the computing system 400 contains one or more alert generation module(s) 408 that is/are in communication with the analysis module 402, the processor 404, and/or the storage media 406. In the example of the computing system 400, the computer system 401A includes the alert generation module 408. The alert generation module 408 may generate an alert indicating when the object 120 crosses or will cross the boundary 130. The alert may be transmitted over the data network (e.g., wireless communication channel or Internet) 410 to, for example, the computer system 401C in the wireless device 412. As mentioned above, in some embodiments, the visual data and/or the signal that generates the alert may be transmitted to a server 409 prior to being transmitted to the computer system 401B or the computer system 401C.

It should be appreciated that computing system 400 is but one example of a computing system, and that computing system 400 may have more or fewer components than shown, may combine additional components not depicted in the example embodiment of FIG. 4, and/or computing system 400 may have a different configuration or arrangement of the components depicted in FIG. 4. The various components shown in FIG. 4 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the invention.

The present disclosure has been described with reference to exemplary embodiments. Although a few embodiments have been shown and described, it will be appreciated by those skilled in the art that changes may be made in these embodiments without departing from the principles and spirit of preceding detailed description. It is intended that the present disclosure be construed as including all such modifications and alterations insofar as they come within the scope of the appended claims or the equivalents thereof.

1. A method for predicting when an object will arrive at a boundary, comprising:
receiving visual media captured by a camera;
identifying an object in the visual media;
determining one or more parameters related to the object based on analysis of the visual media;
predicting when the object will arrive at a boundary using the one or more parameters; and
transmitting an alert to a user indicating when the object is predicted to arrive at the boundary.

2. The method of claim 1, further comprising providing an application to the user for installation on a computer system, wherein the alert is transmitted over a wireless communication channel to a wireless device, and wherein the alert causes the computer system to auto-launch the application when the wireless device is connected to the computer system.

3. The method of claim 2, wherein the computer system is offline when the alert is transmitted.

4. The method of claim 3, wherein the alert includes a uniform resource locator that specifies a data source where the visual media is stored, and wherein the alert enables connection via the uniform resource locator to the data source over the Internet when the wireless device is connected to the computer system and the computer system comes online.

5. The method of claim 1, wherein the one or more parameters comprise a size of the object, a type of the object, or both.

6. The method of claim 5, wherein the one or more parameters comprise a trajectory of the object.

7. The method of claim 6, wherein the one or more parameters comprise a distance between the object and the boundary.

8. The method of claim 7, wherein the one or more parameters comprise a velocity of the object.

9. The method of claim 8, wherein the one or more parameters comprise an acceleration of the object.

10. The method of claim 1, further comprising identifying whether the object is on a predefined path to the boundary.

11. A non-transitory computer-readable medium storing instructions that, when executed by one or more processors of a computer system, cause the computer system to perform operations, the operations comprising:
receiving visual media captured by a camera;
identifying an object in the visual media;
determining one or more parameters related to the object;
predicting when the object will arrive at a boundary using the one or more parameters; and
transmitting an alert over a wireless communication channel to a wireless device, wherein the alert causes a second computer system to auto-launch an application on the second computer system when the wireless device is connected to the second computer system, and wherein the alert indicates when the object is predicted to arrive at the boundary.

12. The non-transitory computer-readable medium of claim 11, wherein the one or more parameters are selected from the group consisting of a size of the object, a type of the object, a trajectory of the object, a distance between the object and the boundary, a velocity of the object, and an acceleration of the object.

13. The non-transitory computer-readable medium of claim 11, wherein the alert indicates an amount of time until the object is predicted to arrive at the boundary.

14. The non-transitory computer-readable medium of claim 11, wherein the alert is generated a predetermined amount of time before the object is predicted to arrive at the boundary.

15. The non-transitory computer-readable medium of claim 11, further comprising identifying whether the object is on a predefined path to the boundary.

16. A system, comprising:
a first computer configured to:
receive visual media captured by a camera;
identify an object in the visual media;
determine one or more parameters related to the object; and
predict when the object will arrive at a boundary using the one or more parameters;
a second computer configured to receive an alert from the first computer that is transmitted over a wireless communication channel, wherein the alert indicates when the object is predicted to arrive at the boundary, and wherein the second computer is a wireless device; and
a third computer having an application stored thereon, wherein the third computer is offline when the alert is transmitted from the first computer, and wherein, when the second computer is connected to the third computer, the alert causes the third computer to auto-launch the application.

17. The system of claim 16, wherein the one or more parameters are selected from the group consisting of a size of the object, a type of the object, a trajectory of the object, a distance between the object and the boundary, a velocity of the object, and an acceleration of the object.

18. The system of claim 16, wherein the alert indicates an amount of time until the object is predicted to arrive at the boundary.

19. The system of claim 16, wherein the alert is generated a predetermined amount of time before the object is predicted to arrive at the boundary.

20. The system of claim 16, further comprising identifying whether the object is on a predefined path to the boundary.
